(19) United States
(12) Patent Application Publication
(10) Pub. No.: US 2007/0198840 A1
(43) Pub. Date: Aug. 23, 2007

(54) System and method for digitally certifying and checking data of a project

(75) Inventors: Chung-I Lee, Tu-Cheng (TW); Chien-Fa Yeh, Tu-Cheng (TW); Bor-Chuan Lin, Tu-Cheng (TW); Chiu-Hua Lu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,923

(22) Filed: Oct. 27, 2006

(30) Foreign Application Priority Data
Feb. 17, 2006 (CN) 200610033807.0

(51) Int. Cl. H04L 9/00

(52) U.S. Cl. 713/176

(57) ABSTRACT

A system for digitally certifying and checking data of a project is provided. The system includes a web server (10), an application (20) server, and a validation server (30). The web server is configured for visiting and operating the application server. The application server is configured for uploading data related to the project, configuring a certifier group, integrating the data into a file package, guiding and helping users including operators, certifiers and project managers to digitally sign the file package, sending the file package digitally signed by each responsible party to the validation server, and receiving validation results from the validation server. The validation server is configured for validating various digital signatures of the signed file package to determine whether each of the digital signatures is valid. A related method is also provided.

### 1. FIELD OF THE INVENTION

The present invention is related to a system and method for digitally certifying and checking data of a project.

### 2. DESCRIPTION OF RELATED ART

Since the emergence and development of computers, work efficiency has greatly improved. Computers have freed workers from repetitive and complicated business procedures, and it has become an indispensable tool in the modern everyday life. Nowadays, more and more tasks are done and processed by computers, including system development, document processing, and engineering drawings. Compared to manual operations, computer operations not only have reduce human and material resources, thus saving operating costs, but have also improve the accuracy of works.

despite the conveniences of computer operations, current tasks such as certify and check procedures of project managements remain done manually. Such manually done tasks are inefficient, and seriously undermine, constrain, and offset the advantages of computer operations. The manual tasks not only waste papers and other material costs, but also create a great inconvenience to the whole work flow because of time and regional differences of various certifiers and project managers.

Accordingly, what is needed is a system and method for digitally certifying and checking data of a project, which can allow certifiers and project managers to certify and check data of a project on remote servers through computer networks, thus, reducing the human and material resources, and enhancing work efficiency.

### SUMMARY OF THE INVENTION

One preferred embodiment provides a system for digitally certifying and checking data of a project. The system includes a web server, an application server, and a validation. The web server is configured for visiting and operating the application server. The application server is configured for uploading data related to the project, configuring a certifier group, integrating the data into a file package, guiding and helping users including operators, certifiers and project managers to digitally sign the file package, sending the file package digitally signed by each responsible party to the validation server, and receiving validation results from the validation server. The validation server is configured for validating various digital signatures of the signed file package to determine whether each of the digital signatures is valid.

Another preferred embodiment provides a method for digitally certifying and checking data of a project. The method includes the steps of: establishing a project; uploading data related to the project; integrating the data into a file package; guiding and helping an operator of the project to digitally sign the file package; configuring a certifier group; guiding and helping each of the certifiers in the certifier group to certify and digitally sign the file package; and guiding and helping one or more project managers of the project to check and digitally sign the file package.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of hardware configuration of a system for digitally certifying and checking data of a project in accordance with one preferred embodiment;

FIG. 2 is a schematic diagram of function modules of an application server in FIG. 1;

FIG. 3 is a flowchart of a method for digitally certifying and checking data of a project in accordance with one preferred embodiment; and

FIG. 4 is a flowchart of details of step S19.

### DETAILED DESCRIPTION OF THE INVENTION

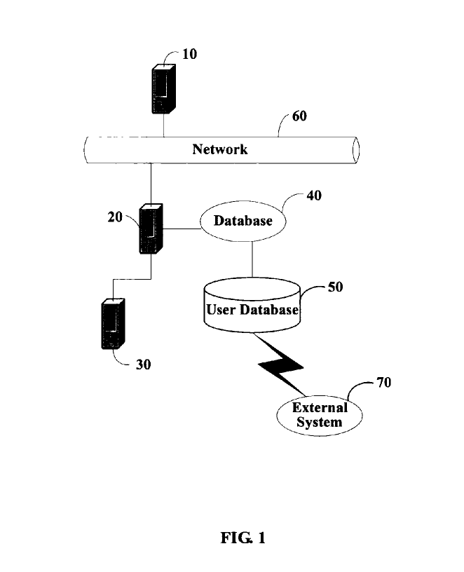

FIG. 1 is a schematic diagram of a hardware configuration of a system for digitally certifying and checking data of a project in accordance with one preferred embodiment. The hardware configuration may typically include a web server 10, an application server 20, a validation server 30, a database 40, a user database 50, a network 60, and an external system 70. The web server 10 is connected with the application server 10 via the network 60. The application server 20 is connected with the validation server 30, and is also connected with the user database 50 via the database 40.

The web server 10 is configured for visiting and operating the application server 20 by operators, certifiers, and project managers of a project. More specifically, the operators can upload data related to the project, integrate the data into a file package, and digitally sign the file package on the application server 20 via the web server 10. The certifiers can also certify and digitally sign the file package, and the project managers can check and digitally sign the file package on the application server 20 via the web server 10. In the preferred embodiment, the operators can be research and development (R&D) engineers, drafting engineers, patent engineers, or the like.

The application server 20 is configured for uploading the data related to the project, integrating the data into a file package, and configuring a certifier group, and for guiding and helping users including operators, certifiers and project managers to digitally sign the file package. The application server 20 is also configured for sending the file package digitally signed by each responsible party to the validation server 30, and receiving validation results from the validation server 30.

The validation server 30 is configured for validating various digital signatures of the file package to determine whether each of the digital signatures is valid. In the preferred embodiment, when the application server 20 sends the file package digitally signed by any of the operators, the certifiers, and the project managers to the validation server 30, the validation server 30 validates a private key of the digital signature by using a corresponding public key stored in the validation server 30, and determines whether the digital signature is valid, and then sends a validation result back to the application server 20.

The database 40 is configured for storing operation logs, workflow information, and users information. The database 40 is connected with the user database 50, furthermore, the users information between the database 40 and the user database 50 can be synchronized.

The user database 50 is configured for storing information of the operators, the certifiers, and the project managers. The user database 50 is connected to the external system 70, so that the operators, the certifiers, and the project managers can modify their information stored on the database 50. In another preferred embodiment, the user database 50 can be integrated with the database 40.

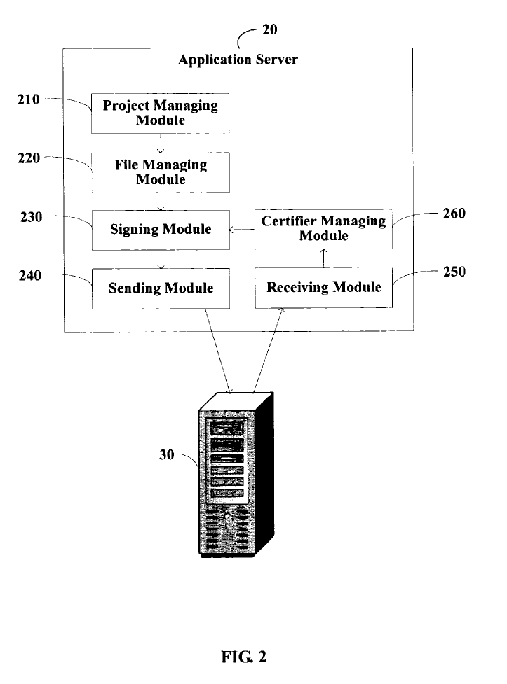

FIG. 2 is a schematic diagram of function modules of the application server 20 in FIG. 1. The application server 20 mainly includes a project managing module 210, a file managing module 220, a signing module 230, a sending module 240, a receiving module 250, and a certifier managing module 260.

The project managing module 210 is configured for adding, modifying, and deleting projects.

The file managing module 220 is configured for uploading, downloading, and modifying data of the project, integrating the data into a file package.

The signing module 230 is configured for guiding and helping users including operators, certifiers and project managers to digitally sign the file package.

The sending module 240 is configured for sending the digitally signed file package signed by each responsible party to the validation server 30 for validation.

The receiving module 250 is configured for receiving validation results from the validation server 30. Wherein, the validation results include validation success information and validation failure information.

The certifier managing module 260 is configured for adding, modifying, and deleting a certifier group or a part of certifiers in the certifier group for the project. Each certifier group includes at least one certifier. The file package can be digitally signed via the signing module 230 by each of the certifiers in the certifier group before it is checked.

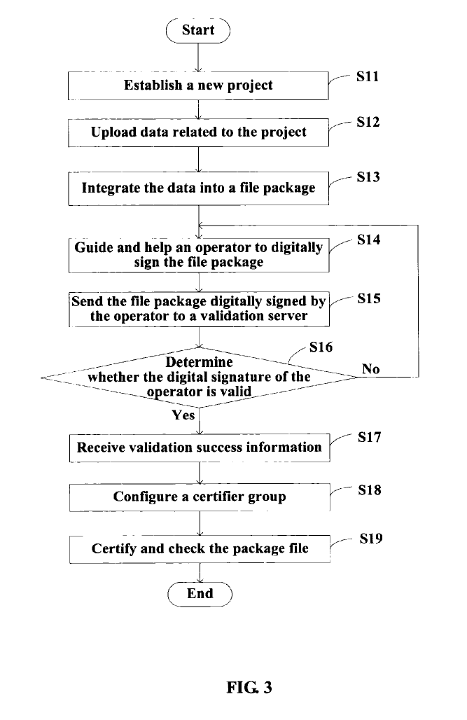

FIG. 3 is a flowchart of a method for digitally certifying and checking data of a project in accordance with one preferred embodiment.

In step S11, the project managing module 210 establishes a new project via the project managing module 210.

In step S12, the file managing module 220 uploads data related to the project.

In step S13, the file managing module 220 integrates the data into a file package.

In step S14, the signing module 230 guides and helps an operator of the project to digitally sign the file package. In the preferred embodiment, the operator can be a research and development (R&D) engineer, a drafting engineer, a patent engineer, or the like.

In step S15, the sending module 240 sends the file package digitally signed by the operator to the validation server 30.

In step S16, the validation server 30 determines whether the digital signature of the operator is valid.

If the digital signature of the operator is not valid, the procedure returns to step S14, and the signing module 230 guides and helps an operator of the project to digitally sign the file package again.

In step S17, if the digital signature of the operator is valid, the receiving module 250 receives validation success information sent from the validation server 30.

In step S18, the certifier managing module 260 configures a certifier group to certify the file package. Wherein, the certifier group includes at least one certifier. In another preferred embodiment, step S18 can be executed before step S12.

In step S19, the signing module 230 guides and helps each of the certifiers in the certifier group and one or more appropriate project managers to digitally sign the file package.

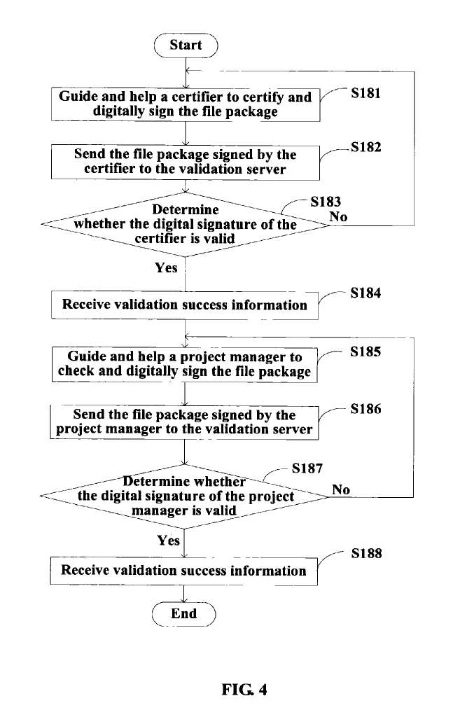

FIG. 4 is a flowchart of details of step S19. In step S181, the signing module 230 guides and helps a certifier in the certifier group to digitally sign the file package.

In step S182, the sending module 240 sends the file package signed by the certifier to the validation server 30.

In step S183, the validation server 30 validates the digital signature of the certifier to determine whether the digital signature is valid.

If the digital signature of the certifier is not valid, the procedure returns to step S181, for the signing module 230 guides and helps a certifier in the certifier group to digitally sign the file package again.

In step S184, if the digital signature of the certifier is valid, the receiving module 250 receives validation success information.

When the file package is certified and signed by another certifier in the certifier group, the procedure repeats steps S181 through S184 until each of the certifier in the certifier group has digitally singed the file package.

In step S185, the signing module 230 guides and helps a project manager of the project to check and digitally sign the file package.

In step S186, the sending module 240 sends the package signed by the project manager to the validation server 30.

In step S187, the validation server 30 validates the digital signature of the project manager to determine whether the digital signature is valid.

If the digital signature of the project manager is not valid, the procedure returns to step S185, for the signing module 230 guides and helps a project manager of the project to check and digitally sign the file package again.

In step S188, if the digital signature of the project manager is valid, the receiving module 250 receives validation success information.

If the file package needs to be checked and signed by another project manager, the procedure repeats steps S186 through S190.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for digitally certifying and checking data of a project, the system comprising a web server, an application server, and a validation server, wherein:
the web server is configured for visiting and operating the application server;
the application server is configured for uploading data related to the project, configuring a certifier group, integrating the data into a file package, guiding and helping users including operators, certifiers and project managers to digitally sign the file package, sending the file package digitally signed by each responsible party to the validation server, and receiving validation results from the validation server; and
the validation server is configured for validating various digital signatures of the signed file package to determine whether each of the digital signatures is valid.

2. The system according to claim 1, wherein the application server comprising:
a project managing module configured for adding, modifying, and deleting the project;
a file managing module configured for uploading, downloading, and modifying the data of the project, integrating the data into the file package;
a signing module configured for guiding and helping users including operators, certifiers and project managers to digitally sign the file package; and
a certifier managing module configured for adding, modifying, and deleting a certifier group or a part of certifiers in the certifier group for the project.

3. The system according to claim 2, wherein the application server further comprising:
a sending module configured for sending the file package signed by each responsible party to the validation server; and
a receiving module configured for receiving validation results from the validation server.

4. A computer-based method for digitally certifying and checking data of a project, the method comprising the steps of:
establishing a project;
uploading data related to the project;
integrating the data into a file package;
guiding and helping an operator of the project to digitally sign the file package;
configuring a certifier group;
guiding and helping each of the certifiers in the certifier group to certify and digitally sign the file package; and
guiding and helping one or more project managers of the project to check and digitally sign the file package.

5. The method according to claim 4, further comprising the steps of:
determining whether the digital signature of the operator is valid;
receiving validation success information if the digital signature is valid; and
returning to the step of guiding and helping an operator of the project to digitally sign the file package if the digital signature of the operator is not valid.

6. The method according to claim 4, further comprising the steps of:
determining whether the digital signature of each of the certifiers is valid;
receiving validation success information if the digital signature of each of the certifiers is valid; and
returning to the step of guiding and helping each of the certifiers in the certifier group to certify and digitally sign the file package if the digital signature of one of the certifiers is not valid.

7. The method according to claim 4, further comprising the steps of:
determining whether the digital signature of each of the project managers is valid;
receiving validation success information if the digital signature of each of the project managers is valid; and
returning to the step of checking and digitally signing the file package by one or more project managers of the project if anyone of the digital signature of one of the project managers is not valid.
